(19) United States
(12) Patent Application Publication
(10) Pub. No.: US 2026/0166452 A1
(43) Pub. Date: Jun. 18, 2026

(54) Water Filter System and Method

(71) Applicant: Keith Bernard, Miramar, FL (US)

(72) Inventor: Keith Bernard, Miramar, FL (US)

(21) Appl. No.: 18/978,144

(22) Filed: Dec. 12, 2024

(51) Int. Cl. B01D 29/58; B01D 29/33; B01D 29/90; B01D 39/16; B01D 39/20; C02F 1/00

(52) U.S. Cl. CPC B01D 29/58; B01D 29/33; B01D 29/902; B01D 39/1661; B01D 39/2055; C02F 1/003; B01D 2201/295; B01D 2201/342; B01D 2201/4092; B01D 2201/44

(57) ABSTRACT

An inline water filter includes between a housing and a filter element an annular space into which water is evenly directed by a disperser including a plurality of water channels.

### FIELD OF THE DISCLOSURE

The invention relates generally to a system and method for water filtration, and more specifically, to an inline water filter including a flow disperser that spreads out incoming water flow about one or more filter elements.

### BACKGROUND

A number of systems exist to filter water. For non-industrial applications where a source of water is a hose and spigot, consumers typically use an inline water filter that is adapted for connection between the spigot or hose, or between two hoses. Such filters may be used, by way of example only, for water provided to campers or to a recreational vehicle while parked at a campsite.

Numerous problems exist with the use of such inline filters. For example, inline filters typically are disposable and need to be changed frequently. They have a limited life span in that once they filter out a certain level of particulates, the inline filter must be changed and disposed of. Inline filters also typically cannot be cleaned for reuse. Further, channeling of water through select sections of filter elements leads to uneven flow across the filter elements, leading to inefficient particulate removal.

Thus, there remains a need for an improved, simple, and cost-effective inline filter system and method for consumer use.

### SUMMARY

The present disclosure provides a system and method for an improved inline water filter for consumer use. The inline water filter includes a housing for one or more water filter elements. A disperser directs incoming water about an annular space between the housing and the filter elements. In this way water flows evenly through all parts of the filter elements and water “channeling” in mainly select parts off the filter elements is avoided.

Other benefits and advantages of the present disclosure will be appreciated from the following detailed description.

### DESCRIPTION OF THE DRAWINGS

Exemplary embodiments of an exemplary water pre-filter system and method are shown in the accompanying drawings.

FIG. 1 is a side view of an exemplary inline water filter in accordance with the present disclosure.

FIG. 2 is a cross-sectional view of the inline water filter described in FIG. 1.

FIG. 3 is an exploded, perspective view from above of the exemplary inline water filter described in FIG. 1.

FIG. 4 is is an exploded, perspective view from below of the exemplary inline water filter described in FIG. 1.

FIG. 5 is a cross-sectional view of the exemplary inline water filter described inn FIG. 1, showing the direction of water flow through the device.

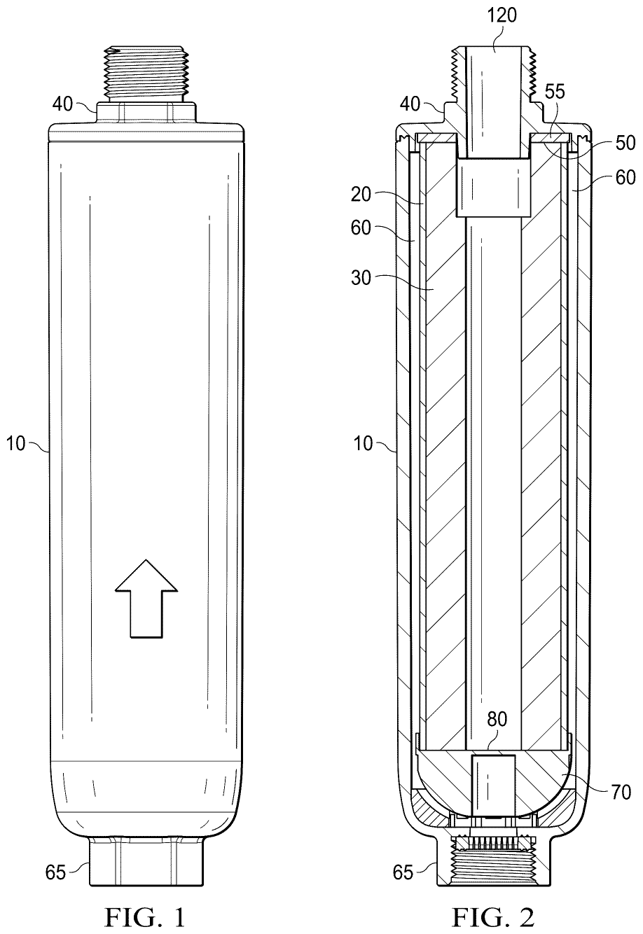

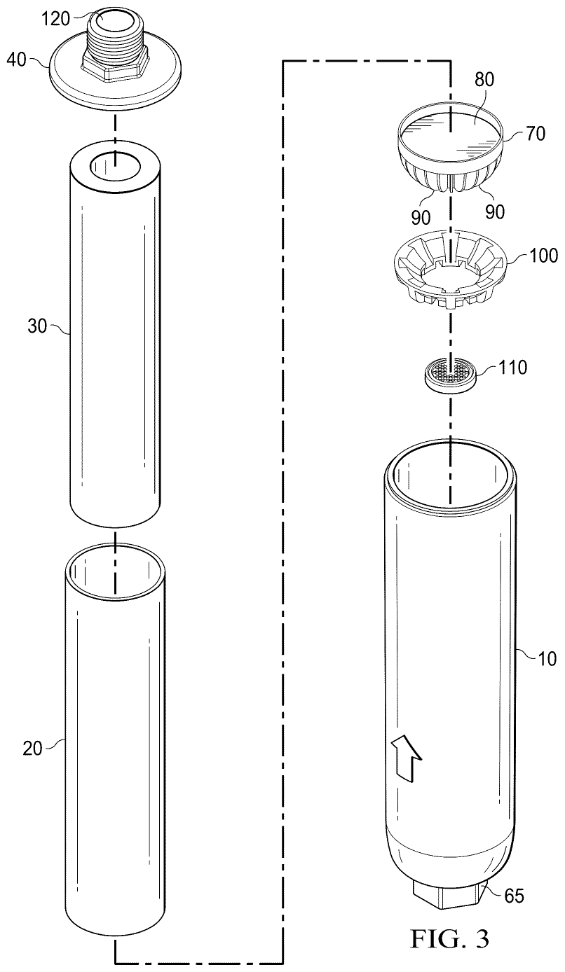

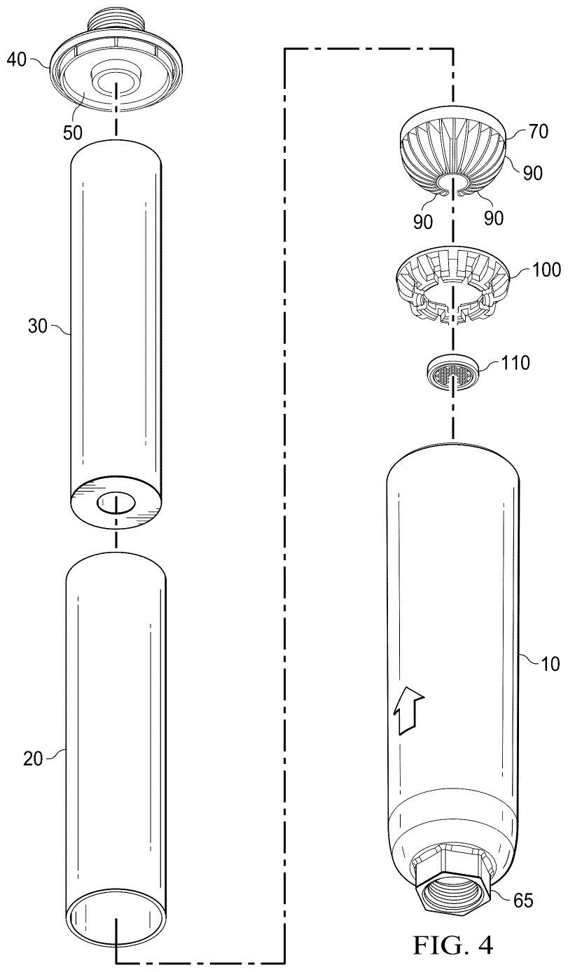

### DETAILED DESCRIPTION

Embodiments of the invention and various alternatives are described. Those skilled in the art will recognize, given the teachings herein, that numerous alternatives and equivalents exist which do not depart from the invention. It is therefore intended that the invention not be limited by the description set forth herein or below.

One or more specific embodiments of the system and method will be described below. These described embodiments are only exemplary of the present disclosure. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Further, for clarity and convenience only, and without limitation, the disclosure (including the drawings) sets forth exemplary representations of only certain aspects of events and/or circumstances related to this disclosure. Those skilled in the art will recognize, given the teachings herein, additional such aspects, events and/or circumstances related to this disclosure, e.g., additional elements of the devices described; events occurring related to water filtering; etc. Such aspects related to this disclosure do not depart from the invention, and it is therefore intended that the invention not be limited by the certain aspects set forth of the events and circumstances related to this disclosure.

Turning now to the drawings, an exemplary system and method for a consumer inline water filter is shown. The system comprises a housing 10, a first filter 20, and a second filter 30. A cap 40 is fixedly attached to the distal end of the housing 10. The cap 40 includes a flat washer-like area 50 formed in the cap 40 or resulting from a separate washer 55 abutting the bottom portion of cap 40. The distal ends of first filter 20 and second filter 30 abut the flat washer-like area 50. The flat washer-like area 50 prevents water in the annular space 60 between the housing 10 and first filter 20 from bypassing the filter 20 by traveling around the distal end of the filter 20. Similarly, the flat washer-like area 50 prevents water between first filter 20 and second filter 30 from bypassing filter 30 by traveling around the distal end of filter 30. In one embodiment, an o-ring or other seal may be provided at one or more of the distal ends of filters 20, 30 to further assist in preventing water bypass.

Water enters the inline filter at threaded connector 65 (e.g., from a connected water spigot or hose). Water passing through connector 65 encounters a disperser 70.

The disperser 70 is configured to evenly distribute water to the annular space 60 between housing 10 and first filter 20. The disperser includes a flat end 80 at its distal side against which the proximal ends of the filters 20, 30 abut. This arrangement prevents water from bypassing the filters 20, 30 by flowing around the proximal ends of the filters 20, 30. The flat end 80 also ensures that incoming water is directed into a plurality of channels 90 that serve to disperse the water evenly to the annular space between housing 10 and first filter 20. The number of channels 90 serving water to the annular space between housing 10 and first filter 20 may vary depending upon the circumstances involved in a particular application, e.g., filter size and water flow rate. The exemplary embodiment shown in the drawings includes twenty-four channels 90.

The disperser 70 at its proximal end abuts a flexible spacer 100. The flexible spacer 100 is compressed between the disperser 70 and connector 65 at the proximal end of housing 10. In that way, the filters 20, 30 are held securely between the flat end 80 of disperser 70 and the flat washer-like area 50 of cap 40. The housing 10 at its distal end may be threadingly engaged with the proximal side of cap 40. This assembly arrangement would permit easy disassembly and reassembly of the inline filter to replace the one or more filters 20, 30. Alternately, the various components of the inline filter may be sonically welded or otherwise fixedly attached to each other.

The first filter 20 may be made of polyethylene (PE) granules that are compacted and sintered to form the tubular shape of the filter 20. The result is a filter that has a solid plastic appearance but is porous with a pore size in one embodiment of approximately fifteen microns. The second filter 30 may be sized to fit within the first filter 20 and may be a carbon filter.

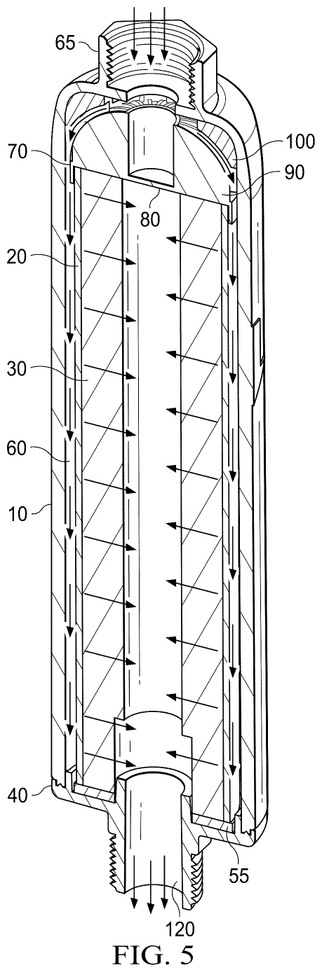

Water entering connector 65 may pass through a screen 110. The water then passes by flexible spacer 100 and to disperser 70. Water enters the channels 90 and then flows evenly into the annular space 60. The water is filtered as it passes through first filter 20 and second filter 30. Water then exits the inline filter through exit 120 in cap 40. See FIG. 5.

Also, while the device may be disassembled and the filters cleaned for repeated use or replaced, the invention is not so limited. In an alternate embodiment a disposable inline filter may be provided. In such an embodiment, threaded couplings may be replaced with fixed couplings. Also, in another embodiment the flexible spacer need not be used. Fixed couplings may be achieved, by way of example, by use of an adhesive or welding process (e.g., sonic welding).

It should be understood that the foregoing description is only illustrative of the invention. Various alternatives and modifications can be devised by those skilled in the art having the benefit of this disclosure, without departing from the invention. Accordingly, the invention is intended to embrace all such alternatives, modifications and variances.

Certain exemplary embodiments of the disclosure may be described. Of course, the embodiments may be modified in form and content, and are not exhaustive, i.e., additional aspects of the disclosure, as well as additional embodiments, will be understood and may be set forth in view of the description herein. Further, while the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention.

What is claimed is:

1. An inline water filter having a proximal end and a distal end, the water filter including:
a tubular-shaped housing defining an inner space;
a tubular-shaped first filter disposed within the inner space to form an annular space between the housing and the first filter; and
a disperser including a plurality of water channels to direct water flowing into the proximal end of the water filter evenly into the annular space.

2. The water filter of claim 1 including a connector at the proximal end of the housing to receive water from a water source.

3. The water filter of claim 1 including a cap threadingly engaged to the distal end of the housing, the cap including a water exit therethrough for water exiting the annular space and passing through the first filter.

4. The water filter of claim 1 including a tubular-shaped second filter disposed within the tubular-shaped first filter.

5. The water filter of claim 4 wherein the distal end of the disperser includes a flat planar section that abuts the proximal end of the first filter and the proximal end of the second filter.

6. The water filter of claim 3 wherein the proximal end of the cap includes a flat portion that abuts the distal end of the first filter and the distal end of the second filter.

7. The water filter of claim 1, wherein the filter includes twenty-four channels.

8. A water filtering method including the step of passing water through a disperser to direct the water evenly about a first water filter.

9. The method of claim 8, wherein the first water filter is tubular-shaped and is disposed within a tubular-shaped housing to create an annular space between the housing and the first water filter, and the water is evenly directed into the annular space by the disperser.

10. The method of claim 9, wherein the water is evenly directed by twenty-four channels.
